(19) United States
(12) Patent Application Publication
(10) Pub. No.: US 2020/0082487 A1
(43) Pub. Date: Mar. 12, 2020

(54) INVENTORY DEPLOYMENT PLANNING DEVICE AND INVENTORY DEPLOYMENT PLANNING METHOD

(71) Applicant: HITACHI, LTD., Tokyo (JP)

(72) Inventors: Naoko KISHIKAWA, Tokyo (JP); Junko HOSODA, Tokyo (JP); Yuhei NIWA, Tokyo (JP)

(21) Appl. No.: 16/452,580

(22) Filed: Jun. 26, 2019

(30) Foreign Application Priority Data
Sep. 6, 2018 (JP) 2018-167116

(51) Int. Cl. G06Q 50/28; G06Q 10/06

(52) U.S. Cl. CPC G06Q 50/28; G06Q 10/06315

(57) ABSTRACT

The inventory deployment planning device includes an inventory deployment planning unit configured to distribute an inventory amount, a delivery amount and a warehousing amount to each warehouse at any ratio based on a total inventory amount of a product, a demand amount and a supply amount of the product and to distribute an operation amount of each operation to a prescribed resource in each warehouse at any ratio based on the inventory amount, the delivery amount and the warehousing amount; a resource number calculation unit configured to calculate the number of required resources of the resource based on the operation amount, and to calculate a total number of resources according to a prescribed rule; a cost calculation unit configured to calculate a resource cost based on the total number of resources; and an optimum inventory deployment selection unit configured to specify an optimum inventory deployment in a supply chain.

### CROSS-REFERENCE TO RELATED APPLICATION

The present application claims priority from Japanese application JP 2018-167116, filed on Sep. 6, 2018, the contents of which is hereby incorporated by reference into this application.

### TECHNICAL FIELD

The present invention relates to an inventory deployment planning device and an inventory deployment planning method.

### BACKGROUND ART

Patent Literature 1 relates to an information processing device, and discloses that “An optimal physical distribution network allowing costs to be minimized is derived based on the demand and supply quantities of items at various physical distribution points and costs for transporting the items in physical distribution networks. Then, a time series simulation on the transition of the demand of the items at important points and the supply quantity of the items at a supply point within the optimal physical distribution network is performed, and it is determined whether or not the result of the simulation satisfies constraint conditions.”

### PRIOR ART LITERATURE

### Patent Literature

PTL 1: JP-A-2012-14372

### SUMMARY OF INVENTION

### Technical Problem

Patent Literature 1 discloses a mechanism that outputs a switching time point at which switching from storage at an intermediate warehouse to storage at a terminal warehouse is performed for the purpose of reducing physical distribution costs constituted by an inventory cost and a transport cost. However, a technique of the same literature does not consider whether or not a plurality of operations such as inventory storage, warehousing and delivery are performed in combination. Therefore, in the technique of the same literature, there is a problem that extra operators and facilities are prepared in each warehouse, which results in inefficiency and an extra cost.

The invention has been made in view of the above problems, and an object thereof is to provide an inventory deployment planning device capable of designing an inventory deployment plan that can further reduce a physical distribution cost by considering performing combined operations.

### Solution to Problem

Although the present application includes a plurality of methods that solves at least apart of the problems described above, an example thereof is given as follows. An inventory deployment planning device according to an aspect of the invention that solves the above problems includes an inventory deployment planning unit configured to distribute an inventory amount, a delivery amount and a warehousing amount to each warehouse at any ratio based on a total inventory amount of a product, a demand amount and a supply amount of the product and to distribute an operation amount of each operation to a prescribed resource in each warehouse at any ratio based on the inventory amount, the delivery amount and the warehousing amount; a resource number calculation unit configured to calculate the number of required resources of the resource based on the operation amount, and to calculate a total number of resources according to a prescribed rule in a case where there are operations that are able to be performed in combination among the operations so that the number of resources is reduced compared to a case where the operations are not able to be performed in combination; a cost calculation unit configured to calculate a resource cost based on the total number of resources; an optimum inventory deployment selection unit configured to specify an optimum inventory deployment in a supply chain in which inventory amounts are distributed to each warehouse at any ratio by using the resource cost.

### Advantageous Effect

According to the inventory deployment planning device of the invention, it is possible to design an inventory deployment plan that can further reduce a physical distribution cost by considering performing combined operations.

### BRIEF DESCRIPTION OF DRAWINGS

FIG. 1 is a diagram showing an example of a schematic configuration of an inventory deployment planning system and a functional configuration of an inventory deployment planning device according to an embodiment of the invention.

FIG. 2 is a diagram showing an example of total inventory amount information according to the embodiment of the invention.

FIG. 3 is a diagram showing an example of customer demand amount information according to the embodiment of the invention.

FIG. 4 is a diagram showing an example of product information according to the embodiment of the invention.

FIG. 5 is a diagram showing an example of warehouse information according to the embodiment of the invention.

FIG. 6 is a diagram showing an example of transport path information according to the embodiment of the invention.

FIGS. 7 (a)-7 (d) are diagrams showing an example of cost information according to the embodiment of the invention. FIG. 7(a) is information showing an example of a condition table. FIG. 7 (b) is a diagram showing an example of a fixed expense table. FIG. 7(c) is a diagram showing an example of a variable expense table. FIG. 7(d) is a diagram showing an example of a resource cost table.

FIG. 8 is a diagram showing an example of combined operation availability information according to the embodiment of the invention.

FIG. 9 is information showing an example of supplier supply amount information according to the embodiment of the invention.

FIG. 10 is information showing an example of operation load information according to the embodiment of the invention.

FIG. 11 is a diagram showing an example of a hardware configuration of the inventory deployment planning device according to the embodiment of the invention.

FIG. 12 is a flowchart showing an example of inventory deployment planning processing according to the embodiment of the invention.

FIG. 13 is a diagram showing an example of screen information on which a physical distribution network diagram is displayed according to the embodiment of the invention.

FIG. 14 is a flowchart showing details of step S200 of generating all combinations of inventory deployments according to the embodiment of the invention.

FIG. 15 is a diagram showing an example of an inventory amount, a delivery amount, a warehousing amount, and a transport amount which are distributed according to the embodiment of the invention.

FIG. 16 is a flowchart showing details of step S300 of calculating the number of required resources according to the embodiment of the invention.

FIG. 17 is a diagram showing an example of screen information that indicates an inventory deployment with the minimum cost according to the embodiment of the invention.

FIG. 18 is a flowchart showing details of step S200 of generating all combinations of inventory deployments according to a second embodiment of the invention.

### DESCRIPTION OF EMBODIMENTS

Embodiments of the invention will be described below with reference to the drawings.

### First Embodiment

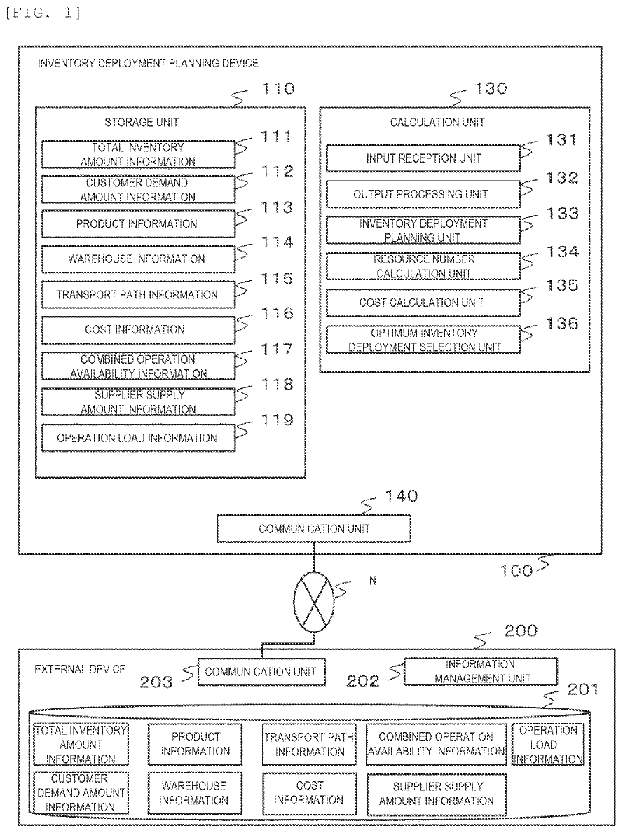

FIG. 1 is a diagram showing an example of a schematic configuration of an inventory deployment planning system and a functional configuration of an inventory deployment planning device 100 according to the embodiment. The inventory deployment planning system includes the inventory deployment planning device 100 and an external device 200 (for example, a server device). The inventory deployment planning device 100 and the external device 200 are communicably connected to each other via a network N. The network is a public network such as Internet, a local area network (LAN), or a wide area network (WAN).

The external device 200 manages information related to physical distribution, a product, a supply chain, a cost, an operation load and the like, and provides the information to the inventory deployment planning device 100. Specifically, the external device 200 includes a database 201 that stores information related to a product amount, information related to a product, information related to a supply chain, and information related to a cost.

More specifically, the external device 200 includes the database 201 that stores total inventory amount information, customer demand amount information, product information, warehouse information, transport path information, cost information, combined operation availability information, supplier supply amount information, and operation load information. Details of the information will be described later.

In addition, the external device 200 includes an information management unit 202 that manages the above-described various types of information, and a communication unit 203 that periodically transmits the information to the inventory deployment planning device 100.

Next, the functional configuration of the inventory deployment planning device 100 will be described. The inventory deployment planning device 100 plans an inventory deployment of a product in consideration of whether or not a plurality of operations can be performed in combination. Specifically, the inventory deployment planning device 100 includes a storage unit 110, a calculation unit 130, and a communication unit 140.

The storage unit 110 is a functional unit that stores (stores) various types of information. Specifically, the storage unit 110 stores total inventory amount information 111, customer demand amount information 112, product information 113, warehouse information 114, transport path information 115, cost information 116, combined operation availability information 117, supplier supply amount information 118, and operation load information 119. The storage unit 110 acquires the information from the external device 200 via the communication unit 140 and stores the information in the storage unit 110.

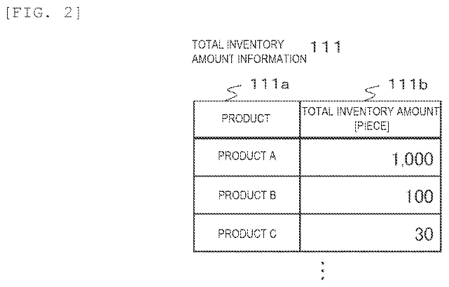

FIG. 2 is a diagram showing an example of the total inventory amount information 111. The total inventory amount information 111 is information that defines a total inventory amount of a product at each base. Specifically, the total inventory amount information 111 includes a record in which a product 111a and a total inventory amount 111b are associated with each other.

The product 111a is information that identifies a product stored in a warehouse serving as a base. The product may be a name of a product, or may be, for example, an ID for identifying a product. The total inventory amount 111b is information that indicates a total inventory amount of a product stored in one warehouse alone or distributed and stored in a plurality of warehouses. A unit of the total inventory amount 111b may be piece, or may be lot or pallet.

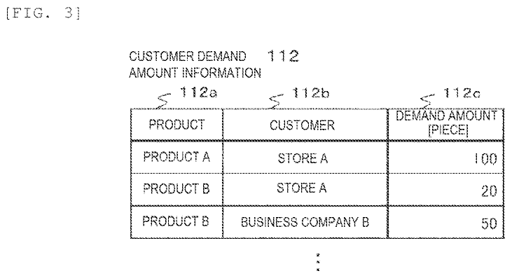

FIG. 3 is a diagram showing an example of the customer demand amount information 112. The customer demand amount information 112 is information that defines a customer demand amount for each of various products. Specifically, the customer demand amount information 112 includes a record in which a product 112a, a customer 112b, and a demand amount 112c are associated with each other.

The product 112a is information that indicates a target product require by a customer. The customer 112b is information that indicates a customer name. The customer 112b may be, for example, an ID for identifying a customer, or may be a name of a market or a warehouse in demand. The demand amount 112c is information that indicates a demand amount of a customer for a product. A unit of the demand amount 112c may be piece, lot, pallet, the number of rows or the number of cases of a received order.

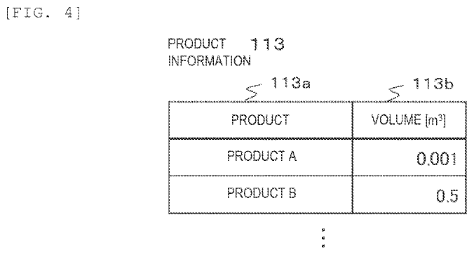

FIG. 4 is a diagram showing an example of the product information 113. The product information 113 is information that defines a volume of a product. Specifically, the product information 113 includes a record in which a product 113a and a volume 113b are associated with each other.

The product name 113a is information that indicates a name of a product. The volume 113b is information that indicates a volume of a product. The product information 113 may be associated with an index value that indicates a load on storage capacity of a warehouse, such as a weight of a product. In addition, the product information 113 may be associated with information related to a facility that a storage destination warehouse should hold, for example, whether refrigeration or a crane is required.

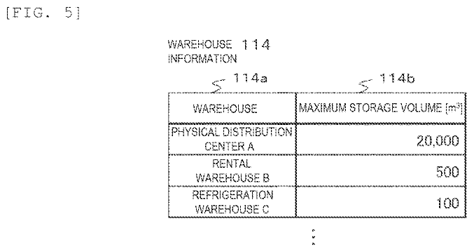

FIG. 5 is a diagram showing an example of the warehouse information 114. The warehouse information 114 is information that defines storage capacity of a warehouse. Specifically, the warehouse information 114 includes a record in which a warehouse 114a and a maximum storage volume 114b are associated with each other.

The warehouse name 114a is information that indicates a name of a warehouse. The maximum storage volume 114b is information that indicates a maximum value of a storage volume of each warehouse. The warehouse information 114 may be associated with an index value that indicates a load on storage capacity of a warehouse, such as a maximum storage number or a maximum storage weight of products. The warehouse information 114 may be associated with an index value that indicates operation capability of a warehouse, such as a maximum warehousing amount or a maximum delivery amount per unit period. Further, the warehouse information 114 may be associated with information related to an installation state of a facility such as with or without a refrigeration function and having or without a crane facility, so as to determine whether storage can be performed according to a product type based on such information.

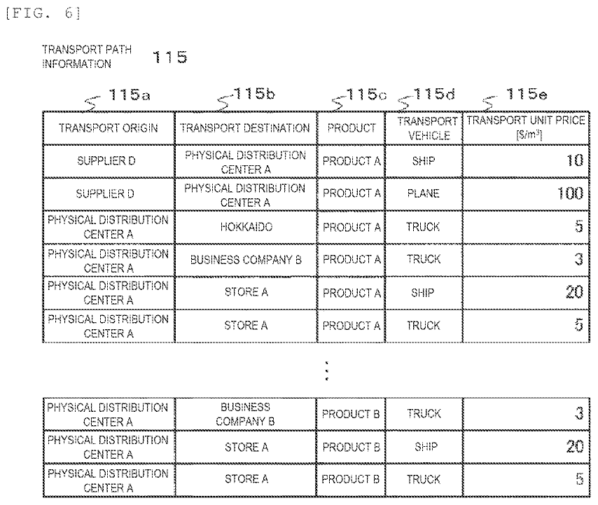

FIG. 6 is a diagram showing an example of the transport path information 115. The transport path information 115 is information that defines a transport origin, a transport destination, a transport vehicle, a transport unit price and the like of a transport path where a product can be transported. Specifically, the transport path information 115 includes a record in which a transport origin 115a, a transport destination 115b, a product 115c, a transport vehicle 115d, and a transport unit price 115e are associated with each other.

The transport origin 115a is information that indicates a name of a transport origin (for example, a supplier or a warehouse) of a product. The transport destination 115b is information that indicates a name of a transport destination (for example, a warehouse or a customer) of a product. The product 115c is information that indicates a name of a product to be transported. The transport vehicle 115d is information that indicates a transport vehicle by which a transport origin and a transport destination are connected. The transport vehicle includes, for example, a ship, a plane or a truck. The transport unit price 115e is information that indicates a unit price necessary for transporting one unit of a product. The transport unit price 115e may be in units of pallets, pieces, one order unit, or weight. In addition, the transport path information 115 may be associated with the maximum transport capacity per unit transport that can be transported by one machine, the maximum number of transports per unit period, or the maximum number of machines per unit period. Further, the transport path information 115 may be associated with information that indicates, for example, a lead time.

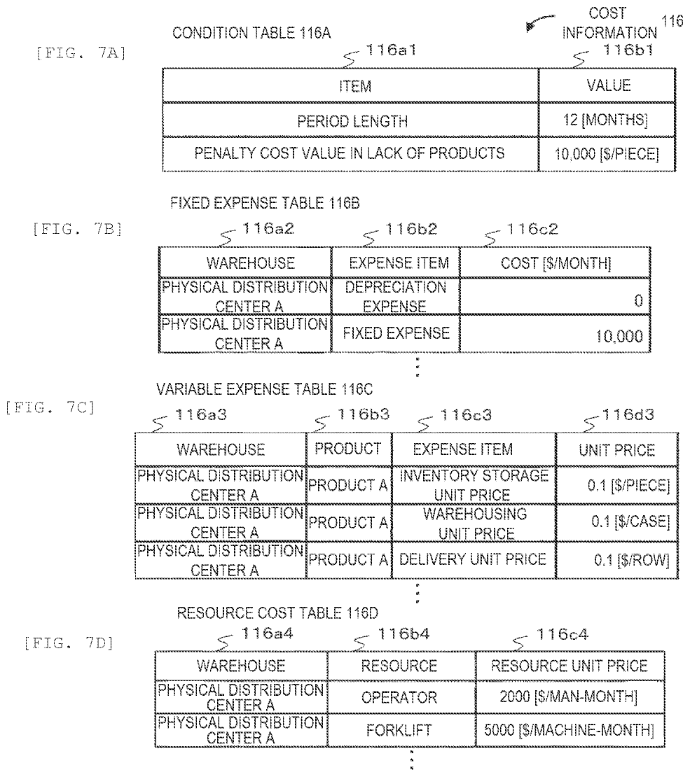

FIGS. 7(a)-7(d) are diagrams showing an example of the cost information 116. The cost information 116 is information that defines various types of costs. Specifically, the cost information 116 includes a condition table 116A, a fixed expense table 116B, a variable expense table 116C, and a resource cost table 116D.

FIG. 7(a) is information showing an example of the condition table 116A. The condition table 116A is information that defines a prescribed condition related to total cost calculation. Specifically, the condition table 116A includes a record in which an item 116a1 and a value 116b1 are associated with each other. In the item 116a1, period length and penalty cost value in lack of products are set. Here, the period is information that indicates a target period in calculating the total cost. In addition, the penalty cost value in lack of products is information that indicates a penalty cost to be incurred in lack of a target product. If the lack is completely acceptable, the penalty cost value may be zero, and if the lack cannot be accepted at all, the penalty cost value may be a very large value such as 1 to the power of thirty. In addition, the penalty cost value may be set for each product or warehouse. A prescribed value is set for each item in the value 116b1.

FIG. 7(b) is a diagram showing an example of the fixed expense table 116B. The fixed expense table 116B is information related to a fixed expense in calculating the total cost. Specifically, the fixed expense table 116B includes a record in which a warehouse 116a2, an expense item 116b2, and a cost 116c2 are associated with each other. The warehouse 116a2 is information that indicates a name of a warehouse. The expense item 116b2 is information that indicates an expense item, for example, a depreciation expense and a fixed expense. The cost 116c2 is information that indicates a cost for an associated expense item.

FIG. 7 (c) is a diagram showing an example of the variable expense table 116C. The variable expense table 116C is information related to a variable expense in calculating the total cost. Specifically, the variable expense table 116C includes a record in which a warehouse 116a3, a product 116b3, an expense item 116c3, and a unit price 116d3 are associated with each other. The warehouse 116a3 is information that indicates a name of a warehouse. The product 116b3 is information that indicates a name of a product. The expense item 116c3 is information that indicates an expense item corresponding to an operation type in a warehouse, for example, an inventory storage unit price, a warehousing unit price, and a delivery unit price. The unit price 116d3 is information that indicates a unit price for inventory storage, warehousing, or delivery. The unit price is a value of a unit price of a variable expense, corresponding to each expense item, per piece, lot and the like which are the unit of a product, or per row, case and the like which are the unit of an order. A unit price may be set for each product when associated with data items of “product”, for example. In addition, a unit price may be set for each resource such as a facility to be used or an operator when associated with data items of “resource”.

FIG. 7(d) is a diagram showing an example of the resource cost table 116D. The resource cost table 116D is information that defines a resource cost. Specifically, the resource cost table 116D includes a record in which a warehouse 116a4, a resource 116b4, and a resource unit price 116c4 are associated with each other. The warehouse 116a4 is information that indicates a name of a warehouse. The resource 116b4 is information that indicates a name of a resource related to, for example, an operator and a facility such as a crane or a robot. The resource unit price 116c4 is information that indicates a unit price of an associated resource.

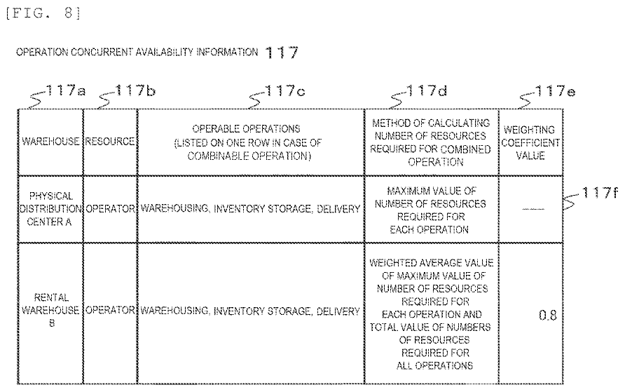

FIG. 8 is a diagram showing an example of the combined operation availability information 117. The combined operation availability information 117 is information that defines whether or not a prescribed resource can perform prescribed operations in combination. Specifically, the combined operation availability information 117 includes a record in which a warehouse 117a, a resource 117b, an operable operations 117c, a method of calculating the number of resources required for combined operations 117d, and a weighting coefficient value 117e are associated with each other.

The warehouse 117a is information that indicates a name of a warehouse. The resource 117b is information that indicates a name of a resource, and may be, for example, an operator, a forklift, or a robot. The operable operations 117c is information that indicates an operable operation in an associated warehouse, in which operations shown in one row are operations that can be performed in combination. For example, a record 117f indicates that an operator who is one of resources of a physical distribution center A can perform operations of warehousing, inventory storage and delivery in combination. The method of calculating the number of resources required for combined operations 117d is information that indicates a method of calculating the number of resources required when performing combined operations, and includes, for example, “maximum value of the number of resources required for each operation” or “a weighted average value of the maximum value of the number of resources required for each operation and a total value of the numbers of resources required for all operations”. The weighting coefficient value 117e is information that indicates a value of a coefficient used in calculating the number of resources required for combined operation. In addition, data items of “number on hand” may be associated, and resources less than the number on hand may be operable without newly investing a resource cost. In addition, data items of “maximum number of resources” may be associated, and the maximum number that can be deployed in a warehouse for each resource may be defined.

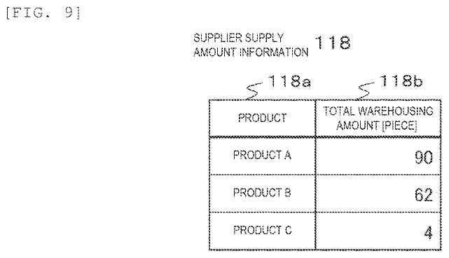

FIG. 9 is information showing an example of the supplier supply amount information 118. The supplier supply amount information 118 is information that defines a supply amount of a product, which is a warehousing amount from a supplier to a warehouse. Specifically, the supplier supply amount information 118 includes a record in which a product 118a and a total warehousing amount 118b are associated with each other.

The product 118a is information that indicates a name of a product supplied by the supplier. The total warehousing amount 118b is information that indicates a total warehousing amount of a product supplied from the supplier to each warehouse, and the like.

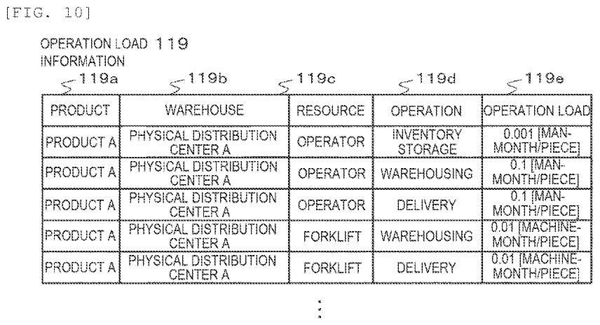

FIG. 10 is information showing an example of the operation load information 119. The operation load information 119 is information that defines a degree of an operation load of a resource. Specifically, the operation load information 119 includes a record in which a product 119a, a warehouse 119b, a resource 119c, an operation 119d, and an operation load 119e are associated with each other.

The product 119a is information that indicates a name of a product to be operated by a resource. The warehouse 119b is information that indicates a name of a warehouse to which a resource belongs. The resource 119c is information that indicates a name of a resource, and the resource includes, for example, an operator, a forklift, and a robot. The operation 119d is information that indicates a name of an operation, and includes, for example, inventory storage, warehousing, and delivery. The operation load 119e is information that indicates a degree of an operation load of a resource for an associated product.

Description will be given returning to FIG. 1. The calculation unit 130 is a functional unit that executes various processing in the inventory deployment planning device 100. Specifically, the calculation unit 130 includes an input reception unit 131, an output processing unit 132, an inventory deployment planning unit 133, a resource number calculation unit 134, a cost calculation unit 135, and an optimum inventory deployment selection unit 136.

The input reception unit 131 is a functional unit configured to receive input information from a user via an input device such as a keyboard or a mouse. Further, the input reception unit 131 is also configured to acquire various types of information stored in the storage unit 110. Further, the input reception unit 131 is also configured to transfer the input information to a corresponding functional unit of the calculation unit 130.

The output processing unit 132 is a functional unit configured to generate screen information to be displayed on a display device. Specifically, the output processing unit 132 generates the screen information to be displayed on an output device (for example, a display) provided in the inventory deployment planning device 100.

The inventory deployment planning unit 133 is a functional unit configured to execute inventory deployment planning processing. For example, the inventory deployment planning unit 133 executes the inventory deployment planning processing, and generates a physical distribution network diagram that indicates a supply chain by using prescribed input information.

The resource number calculation unit 134 is a functional unit configured to calculate the required number of resources. Specifically, in the inventory deployment planning processing, the resource number calculation unit 134 calculates the required number of resources for each product in each warehouse.

The cost calculation unit 135 is a functional unit configured to calculate a cost. Specifically, the cost calculation unit 135 executes prescribed processing for calculating a total cost in the inventory deployment planning processing.

The optimum inventory deployment selection unit 136 is a functional unit configured to select an optimal inventory deployment with the minimum total cost. Specifically, in the inventory deployment planning processing, the optimum inventory deployment selection unit 136 specifies and selects an inventory deployment with the minimum calculated total cost, and displays prescribed information related to the inventory deployment via the output processing unit 132.

The communication unit 140 is a functional unit configured to communicate information with the external device 200. Specifically, the communication unit 140 acquires, from the external device 200, the total inventory amount information 111, the customer demand amount information 112, the product information 113, the warehouse information 114, the transport path information 115, the cost information 116, the combined operation availability information 117, the supplier supply amount information 118, and the operation load information 119.

The functional configuration of the inventory deployment planning device 100 has been described above.

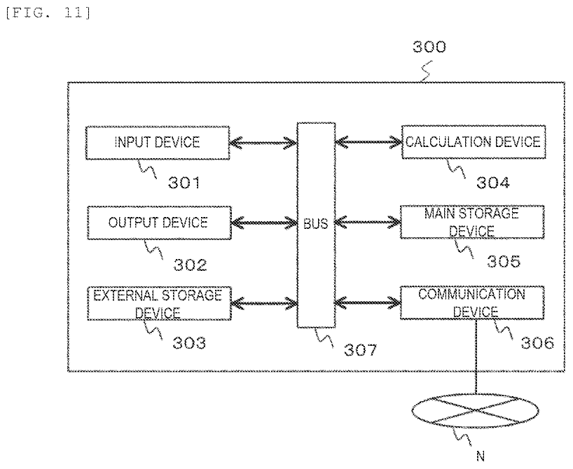

FIG. 11 is a diagram showing an example of a hardware configuration of the inventory deployment planning device 100. The inventory deployment planning device 100 is realized by, for example, a high-performance information processing device.

An input device 301 is a pointing device such as a keyboard, a mouse, or a touch panel. An output device 302 is a printer or a display device such as a liquid crystal display or an organic display.

An external storage device 303 is a nonvolatile storage device capable of storing digital information such as a hard disk drive, a solid state drive (SSD), or a flash memory.

A calculation device 304 is, for example, a central processing unit (CPU). A main storage device 305 is a memory device such as a random access memory (RAM) or a read only memory (ROM).

A communication device 306 is a wired communication device that performs wired communication via a network cable or a wireless communication device that performs wireless communication via an antenna. The communication device 306 performs information communication with the external device 200 connected to a network N.

The calculation unit 130 of the inventory deployment planning device 100 is realized by a program that causes the calculation device 304 to perform processing. The program is stored in the main storage device 305 or the external storage device 303, loaded on the main storage device 305 in execution of the program, and executed by the calculation device 304. Further, the storage unit 110 is realized by the main storage device 305, the external storage device 303, or a combination thereof. Further, the communication unit 140 is realized by the communication device 306.

Further, each of the above-described configurations, functions, processing units, processing methods, and the like of the inventory deployment planning device 100 may be realized in hardware, for example, by designing a part or all of them with an integrated circuit. In addition, the configurations and functions may be realized in software by a processor interpreting and executing a program that realizes each function. Information such as a program that realizes each function, a table, and a file can be stored in a storage device such as a memory, a hard disk, or an SSD, or a recording medium such as an IC card, an SD card, or a DVD.

Further, the hardware configuration of the inventory deployment planning device 100 is not limited thereto, and may be configured by using other hardware. For example, a device that receives input and output via Internet may be used. Although not shown, the inventory deployment planning device 100 includes known elements such as an operating system (OS), middleware, and an application, and particularly has an existing processing function used for displaying a GUI screen on the output device 302 such as a display.

The inventory deployment planning device 100 may have functions and configurations of the external device 200 therein. In this case, various types of information stored in the database 201 of the external device 200 may be stored in advance, for example, in the external storage device 303 of the inventory deployment planning device 100. The hardware configurations of the inventory deployment planning device 100 and the external device 200 may be arranged in a distributed manner.

The hardware configuration of the inventory deployment planning device 100 has been described above.

[Description of Operation]

Next, the inventory deployment planning processing executed by the inventory deployment planning device 100 will be described.

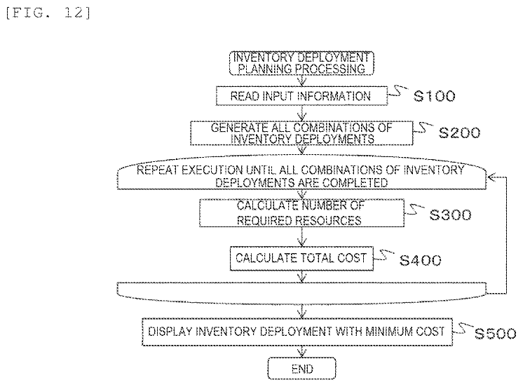

FIG. 12 is a flowchart showing an example of the inventory deployment planning processing. The inventory deployment planning processing is started when the input reception unit 131 receives an execution instruction of the processing from a user via a prescribed menu screen displayed on the display device, for example.

When the processing is started, the inventory deployment planning unit 133 reads input information from the storage unit 110 (step S100). Specifically, the inventory deployment planning unit 133 acquires and reads, from the storage unit 110, the total inventory amount information 111, the customer demand amount information 112, the product information 113, the warehouse information 114, the transport path information 115, the cost information 116, the combined operation availability information 117, the supplier supply amount information 118, and the operation load information 119.

Here, the inventory deployment planning unit 133 generates a network diagram (hereinafter, referred to as a “physical distribution network diagram”) that indicates candidates of a base and a physical distribution path by using the acquired information, and displays the generated physical distribution network diagram via the output processing unit 132. It should be noted that the physical distribution network indicates a supply chain.

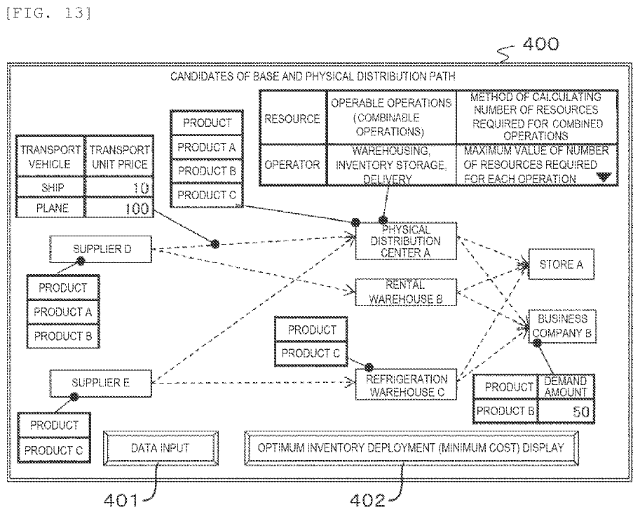

FIG. 13 is a diagram showing an example of screen information 400 on which the physical distribution network diagram is displayed. The inventory deployment planning device 100 links a transport origin and a transport destination of a product when generating the physical distribution network diagram. Specifically, the inventory deployment planning unit 133 specifies the transport origin and the transport destination by using the transport path information 115. The inventory deployment planning unit 133 connects the specified transport origin and transport destination with an arrow line. Accordingly, for example, a supplier D and the physical distribution center A are connected by an arrow line.

Further, the inventory deployment planning unit 133 links a transport vehicle and a transport unit price with the arrow line that connects the transport destination from the transport origin. Specifically, the inventory deployment planning unit 133 specifies the transport vehicle and the transport unit price from the transport origin to the transport destination by using the transport path information 115, and associates them with the arrow line between the transport origin and the transport destination. Accordingly, for example, a ship which is the transportation vehicle and a transport unit price “10” are associated with the arrow line that connects the supplier D (the transport origin) and the physical distribution center A (the transport destination).

In addition, the inventory deployment planning unit 133 links products to be transported from or to be arrived at each base. Specifically, the inventory deployment planning unit 133 specifies each base by using the transport path information 115. In addition, the inventory deployment planning unit 133 associates a product of associated products with each specified base. Accordingly, for example, a product (product A and product B) to be transported is associated with the supplier D, and a product (product A, product B, and product C) to be arrived is associated with the physical distribution center A.

The inventory deployment planning unit 133 links a resource, operable operations, and the like with each warehouse. Specifically, an inventory planning design unit specifies a warehouse, and a resource, operable operations, and a method of calculating the number of resources required for combined operations which are associated with the warehouse by using the combined operation availability information 117. The inventory deployment planning unit 133 associates each warehouse on the physical distribution network with a corresponding resource, operable operations, and a method of calculating the number of resources required for combined operations. Accordingly, for example, the physical distribution center A is associated with the resource (an operator), the operable operations (warehousing, inventory storage, delivery), the method of calculating the number of resources required for combined operations (the maximum number of resources required for each operation).

The inventory deployment planning unit 133 links a demand number of a product with each customer. Specifically, the inventory deployment planning unit 133 specifies a product, a customer, and a demand amount by using the customer demand amount information 112. Further, the inventory deployment planning unit 133 associates a corresponding product and a demand amount with each customer (such as store A or business company B) connected by the arrow line on the physical distribution network diagram. Accordingly, for example, the product B and a demand amount 50 are associated with the business company B.

Although not shown in FIG. 13, it is assumed that a transport vehicle and a transport unit price are also associated with the arrow line between the supplier D and a rental warehouse B, and the arrow line between a supplier E, the physical distribution center A and a refrigeration warehouse C. In addition, it is assumed that a product, a resource, and the like are also associated with the rental warehouse B and the refrigeration warehouse C. Further, it is assumed that a product and a demand amount are also associated with the store A.

As shown in FIG. 13, a data input button 401 and an optimum inventory deployment (minimum cost) display button 402 are displayed in the screen information. When receiving a press of the data input button 401, the input reception unit 131 individually displays input information read in step S100 via the output processing unit 132, and receives an update for the input information from the user. When receiving a press of the optimum inventory deployment (minimum cost) display button 402, the input reception unit 131 executes the processing of step S200 and subsequent steps in the inventory deployment planning processing. Processing in a case where the optimum inventory deployment (minimum cost) display button 402 is pressed will be described below.

In step S200, the inventory deployment planning unit 133 generates all combinations of inventory deployments.

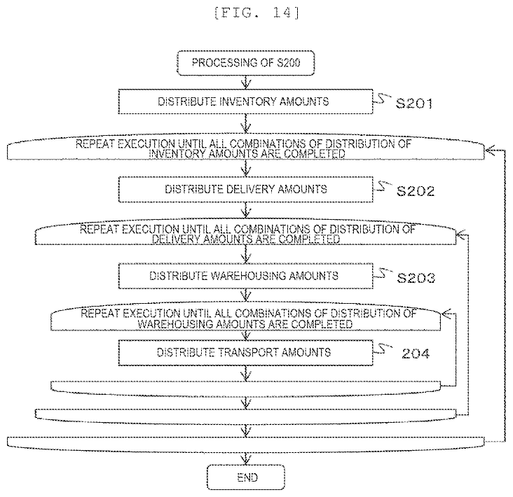

FIG. 14 is a flowchart showing details of step S200 of generating all combinations of the inventory deployments. In step S201, the inventory deployment planning unit 133 distributes an inventory amount to each warehouse. Specifically, the inventory deployment plan distributes the inventory amount to each warehouse in a manner that covers any ratio and all combinations so that a sum of inventory amount of each product is the total inventory amount of the total inventory amount information 111.

For example, in the total inventory amount information 111 in FIG. 2, the total inventory amount of the product A is 1000 pieces. Therefore, the inventory amount of the product A is distributed at a ratio, for example, 350 pieces to the physical distribution center A, 350 pieces to the rental warehouse B, and 300 pieces to the refrigeration warehouse C so that the sum of the distribution amounts is 1000 pieces. In addition to the above combination, the inventory amount is distributed in a manner that covers any ratio and all combinations, for example, 351 pieces to the physical distribution center A, 349 pieces to the rental warehouse B, and 300 pieces to the refrigeration warehouse C.

The inventory deployment planning unit 133 determines a ratio of the inventory amount to be distributed within a range in which the distribution amount of each product does not exceed the maximum storage capacity of each warehouse. Specifically, the inventory deployment planning unit 133 specifies a volume of each product based on the product information 113, and distributes the inventory amount of each product within a range in which a volume for the distribution amount does not exceed the maximum storage volume defined in the warehouse information 114.

Next, the inventory deployment planning unit 133 distributes a delivery amount to each warehouse (step S202). Specifically, for each combination of inventory amounts distributed to each warehouse, the inventory deployment planning unit 133 distributes a delivery amount to each warehouse in a manner that covers any ratio and all combinations so that the total delivery amount of each product is equal to a sum of a demand amount for each product defined in the customer demand amount information 112. When exceeding an index value that indicates maximum operation capacity of the warehouse such as the maximum delivery amount per unit period in the warehouse information 114, such a combination of distribution is excluded from subsequent processing as being unrealizable. The processing of step S202 is repeatedly executed until all combinations of the distribution of the inventory amount are completed.

For example, in the customer demand amount information 112 in FIG. 3, the demand amount for the product A in the store A is 100 pieces. Therefore, the delivery amount of the product A is distributed at a ratio, for example, 80 pieces to the physical distribution center A, 15 pieces to the rental warehouse B, and 5 pieces to the refrigeration warehouse C so that the total distribution amount is 100 pieces. In addition to the above combination, for example, the delivery amount is distributed in a manner that covers any ratio and all combinations, for example, 79 pieces to the physical distribution center A, 16 pieces to the rental warehouse B, and 5 pieces to the refrigeration warehouse C.

Further, when the index value that indicates the maximum operation capacity of the warehouse such as the maximum delivery amount per unit period is associated in the warehouse information 114, the inventory deployment planning unit 133 determines a delivery amount to be distributed within a range not exceeding the maximum operation capacity.

Next, the inventory deployment planning unit 133 distributes an inventory amount to each warehouse (step S203). Specifically, for each combination of the inventory amount and the delivery amount which are distributed, the inventory deployment planning unit 133 distributes the warehousing amount to each warehouse in a manner that covers any ratio and all combinations so that the total warehousing amount of each product is equal to a sum of the total inventory amounts for each product defined in the supplier supply amount information 118. The processing of step S203 is repeatedly executed until all combinations of the distribution of the delivery amount are completed.

For example, in the supplier supply amount information 118 in FIG. 9, the total warehousing amount of the product A is 90 pieces. Therefore, the warehousing amount of the product A is distributed at a ratio, for example, 70 pieces to the physical distribution center A, 10 pieces to the warehouse B, and 10 pieces to the refrigeration warehouse C so that a sum of the distribution amounts is 90 pieces. In addition to the above combination, the warehousing amount is distributed in a manner that covers any ratio and all combinations, for example, 71 pieces to the physical distribution center A, 10 pieces to the warehouse B, and 9 pieces to the refrigeration warehouse B.

When an index value that indicates the maximum operation capacity of the warehouse such as the maximum warehousing amount per unit period is associated in the warehouse information 114, the inventory deployment planning unit 133 determines the warehousing amount to be distributed within a range not exceeding the maximum operation capacity.

Next, the inventory deployment planning unit 133 distributes a transport amount to each transport path (step S204). Specifically, for each combination of the inventory amount, the delivery amount and the warehousing amount which are distributed, the inventory deployment planning unit 133 distributes the transport amount of a product to each transport path in which a target warehouse is set as a transport origin in a manner that covers any ratio and all combinations so that the transport amount is equal to the delivery amount distributed in step S202. The processing of step S204 is repeatedly executed until all combinations of the distribution of the warehousing amounts are completed.

In addition, the inventory deployment planning unit 133 distributes the transport amount of a product to a transport path in which a target warehouse is set as a transport destination in a manner that covers any ratio and all combinations so that the transport amount is equal to the warehousing amount of each product in each warehouse distributed in step S203. The inventory deployment planning unit 133 distributes the transport amount of a product to each transport vehicle in a manner that covers any ratio and all combinations. When an index value that indicates the maximum transport capacity of the transport path such as the maximum transport amount per unit period is associated in the transport path information 115, the inventory deployment planning unit 133 determines the transport amount to be distributed within a range not exceeding the maximum transport capacity.

For example, the delivery amount of the physical distribution center A for the product A is 80 pieces, and the transport vehicle of the transport path that connects the physical distribution center A and the store A includes a truck and a ship. Therefore, the transport amount of the transport path that connects the physical distribution center A and the store A is distributed at a ratio, for example, 50 pieces to the truck and 30 pieces to the ship so that the total distribution amount is 80 pieces.

For example, the warehousing amount of the physical distribution center A for the product A is 70 pieces, and the transport vehicle of the transport path that connects the supplier D and the physical distribution center A includes a ship and an airplane. Therefore, the transport amount of the transport path that connects the supplier D and the physical distribution center A is distributed at a ratio, for example, 50 pieces to the ship and 20 pieces to the airplane so that the total distribution amount is 70 pieces. In addition to the above combination, the transport amount is distributed in a manner that covers any ratio and all combinations, for example, 51 pieces to the ship and 19 pieces to the airplane.

In this way, the inventory deployment planning unit 133 obtains all combinations of the inventory amounts, and obtains all combinations of the delivery amounts for each combination of the inventory amounts. In addition, the inventory deployment planning unit 133 obtains all combinations of the warehousing amounts for each combination of the delivery amounts, and obtains all combinations of the transport amounts for each combination of the warehousing amounts.

Further, when the processing is completed, the inventory deployment planning unit 133 ends the processing of the flow. The above calculation assumes that first data (a top record) related to the product or the warehouse included in, for example, the product information 113, the warehouse information 114, and the transport path information 115 is a starting point of calculation and proceeds toward an end of the data. In addition, a calculation method can be realized by using a known recursive calculation algorithm and the like.

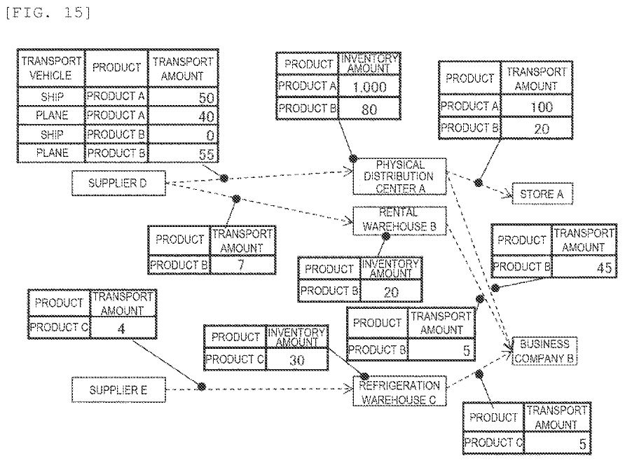

FIG. 15 is a diagram showing an example of the inventory amount, the delivery amount, the warehousing amount, and the transport amount which are distributed by the processing of step S201 to step S204. As shown in the drawing, the inventory amount for each product is distributed to each warehouse at any ratio. In addition, the transport path that connects each warehouse and a customer such as the store A is associated with the delivery amount for each product distributed to each warehouse at any ratio. The transport path that connects a supplier and each warehouse is associated with the warehousing amount for each product distributed to each warehouse at any ratio.

Description will be given returning to FIG. 12. Next, the resource number calculation unit 134 calculates the number of required resources (step S300). The processing of step S300 and step S400 which will be described later, are repeatedly executed until all combinations of inventory deployments are completed.

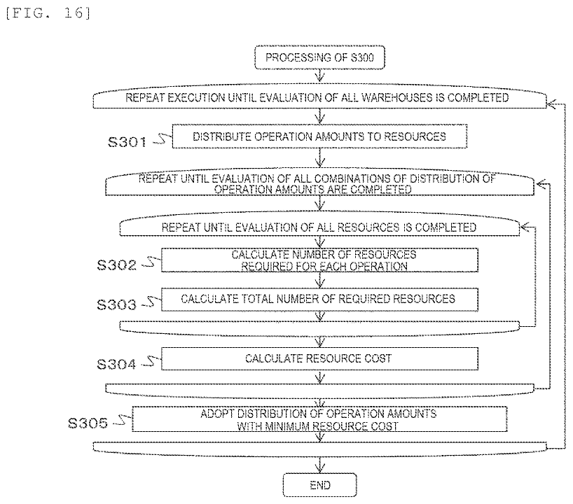

FIG. 16 is a flowchart showing details of step S300 of calculating the number of required resources. In step S301, the resource number calculation unit 134 distributes an operation amount to the resources of each warehouse. Specifically, for each warehouse, the resource number calculation unit 134 distributes the operation amount (the inventory amount, the warehousing amount, and the delivery amount) of an operation, for example, inventory storage, warehousing, and delivery of each product to an operator, a forklift, and a robot which are resources in a manner that covers any ratio and all combinations. The processing of step S301 is repeatedly executed until evaluation of all warehouses is completed.

Specifically, the resource number calculation unit 134 specifies an operable resource for each product in each warehouse by using the operation load information 119. The resource number calculation unit 134 uses, for example, the operation load information to specify that the operable resource related to inventory storage for the product A is only an operator, and the operable resource related to warehousing and delivery are an operator and a forklift, respectively.

For example, when the operation amounts, that is, the inventory amount, the warehousing amount, and the delivery amount of the product A in the physical distribution center A are 1000 pieces (the inventory amount), 100 pieces (the warehousing amount), and 80 pieces (the delivery amount), the resource number calculation unit 134 distributes the operation amount of 1000 pieces related to the inventory storage entirely to the operator who is the only resource specified for the inventory storage. Similarly, the resource number calculation unit 134 distributes the operation amount related to the warehousing at a ratio such as 30 pieces to the operator and 70 pieces to the forklift among the specified resources. Similarly, the resource number calculation unit 134 distributes the operation amount related to the delivery at a ratio such as 20 pieces to the operator and 60 pieces to the forklift among the specified resources.

Next, the resource number calculation unit 134 calculates the number of resources required for each product and each operation (step S302). Specifically, for each combination of the distributed operation amounts, the resource number calculation unit 134 calculates the number of resources required for each product and each operation by using the following Equation (1).

required number of resources required for operation j by resource r=Σproduct(required number of resources required for operation j of product p by resource r) (Equation 1)

The resource number calculation unit 134 specifies the operation load of a target resource associated with a target product of a target warehouse by using the operation load information 119. Further, the resource number calculation unit 134 calculates the number of resources required for each product and each operation in a target warehouse by multiplying the specified operation load by the distributed operation amount. The (number of resources required for operation j of product p by resource r) is expressed by the following Equation (2).

required number of resources required for operation j of product p by resource r=operation load of operation j of product p by resource r×(operation amount distributed to resource r among operation j of product p) (Equation 2)

Here, for example, a case in which the number of resources required for the product A in the physical distribution center A is obtained will be described as an example. It is assumed that the operation amount for each resource distributed in step S301 is: for an operator, the inventory storage amount=1000 pieces, the warehousing amount=30 pieces, and the delivery amount=20 pieces, and for a forklift, the warehousing amount=70 pieces and the delivery amount=60 pieces. Further, as shown in the operation load information 119 in FIG. 10, it is assumed that an operation load of a resource is: the operation load related to inventory storage of the operator=0.001 [man-month/piece], the operation load related to warehousing and delivery of the operator=0.1 (man-month/piece), and the operation load related to warehousing and delivery of the forklift=0.01 (machine-month/piece).

Using Equation (2), the resource number calculation unit 134 obtains the required number of resources required for the inventory storage operation by the operator=0.001 (man-month/piece)×1000 (pieces)=1 (man-month).

In addition, the resource number calculation unit 134 obtains the required number of resources required for the warehousing operation by the operator=0.1 (man-month/piece)×30 (pieces)=3 (man-month).

In addition, the resource number calculation unit 134 obtains the required number of resources required for the delivery operation by the operator=0.1 (man-month/piece)×20 (pieces)=2 (man-month).

In addition, the resource number calculation unit 134 obtains the required number of resources required for the warehousing operation by the forklift=0.01 (machine-month/piece)×70 (pieces)=0.7 (machine-month).

In addition, the resource number calculation unit 134 obtains the required number of resources required for the delivery operation by the forklift=0.01 (machine-month/piece)×60 (pieces)=0.6 (machine-month).

Similarly, for the product B in the physical distribution center A, for example, it is assumed that the required numbers of resources required for an inventory storage operation, an warehousing operation, and an delivery operation by an operator is 1.1 (man-month), 2 (man-month), and 2 (man-month), respectively, and the required numbers of resources required for an warehousing operation and an delivery operation by a forklift is respectively calculated as 0.5 (machine-month) and 0.4 (machine-month).

Next, for all products, the resource number calculation unit 134 obtains a required number of resources required for an operation j of all products by a resource r by adding the required numbers of resources required for the operation j of each product by the resource r by using the following Equation (3) for each operation.

required number of resources required for operation j of all products by resource r=Σ_{(all products p)}{required number of resources required for operation j of product p by resource r} Equation (3)

In this case, the required number of resources required for the inventory storage operation of all products by the operator in the physical distribution center A is 1+1.1=2.1 [man-month]. Similarly, the required number of resources required for the warehousing operation and the delivery operation of all products by the operator is 3+2=5 (man-month), and 2+2=4 (man-month), respectively. In addition, the required number of resources required for the warehousing operation and the delivery operation of all products by the forklift is 0.7+0.5=1.2 (machine-month), and 0.6+0.4=1.0 (machine-month), respectively.

Next, the resource number calculation unit 134 calculates a total number of required resources in each warehouse based on “method of calculating the number of resources required for combined operation” defined in combined operation availability information 117 (step S303). Hereinafter, “method of calculating the number of resources required for combined operation” is divided into a case of “maximum value of the number of resources required for each operation” and a case of “weighted average value of the maximum value of the number of resources required for each operation and a total value of the numbers of resources required for all operations” will be described separately.

The operable operation for which “maximum value of the number of resources required for each operation” is defined in the combined operation availability information 117 is a sufficient operation if operation time of each operation does not overlap with each other and resources are prepared for the number of resources required for the operation with the largest number of required resources. Therefore, the resource number calculation unit 134 calculates a total number of required resources by using the following Equation (4).

total number of required resources of resource r=Max(required number of resources required for each operation by resource r) (Equation 4)

For example, a total number of required resources related to operators of all products in the physical distribution center A is the total number of required resources of the operators=Max (2.1, 5, 4)=5 (man-month).

A total number of required resources related to forklifts of all products in the physical distribution center A is the total number of required resources of the forklifts=Max (1.2, 1)=1.2 (machine-month).

Further, in the operable operations for which “weighted average value of the maximum value of the number of resources required for each operation and the total value of numbers of resources required for all operations” is defined in the combined operation availability information 117, the operation time of each operation overlaps, so that the total number of required resources is between a total value of the number of resources required for the operation with the largest number of necessary resources and the number of resources required for all operations. Therefore, the resource number calculation unit 134 calculates the total number of required resources in this case based on the following Equation (5) by using a weight coefficient value of the combined operation availability information 117.

total number of required resources of resource r=weighting coefficient k×Max(required number of resources required for each operation by resource r)+(1−k)×Σ(required number of resources required for each operation by resource r Equation (5)

For example, when the required numbers of resources required for the inventory storage operation, the warehousing operation, and the delivery operation by the operator of all products in the rental warehouse B are 0.3, 0.5, and 1.0, respectively, and the weight coefficient value of the associated combined operation availability information 117=0.8, the total number of required resources related to the operator=0.8×Max (0.3, 0.5, 1.0)+0.2×Σ (0.3, 0.5, 1.0)=0.8+0.36=1.16 (man-month).

In addition, when the required numbers of required resources required for the inventory storage operation, the warehousing operation, and the delivery operation by the operator of all products in the rental warehouse B are 1.0, 0.5 and 2.0, respectively, and the weight coefficient value of the associated combined operation availability information 117=0.8, the total number of required resources for the forklift=0.8×Max (1.0, 0.5, 2.0)+0.2×Σ (1.0, 0.5, 2.0)=1.6+0.7=2.3 (machine-month).

When there is no operation that can be performed in combination, the resource number calculation unit 134 performs calculation by summing up the numbers of required resources in each resource obtained for each operation. In addition, for example, when only two of three operations are the operations that can be performed in combination and the other one of the three operations is the operation that cannot be performed in combination, the resource number calculation unit 134 obtains the number of resources required for the operations that can be performed in combination by using Equation (4) or Equation (5), and sums up with the number of resources required for the operation that cannot be performed in combination, so as to calculate the total number of required resources in a case where the operations that can be performed in combination and the operation that cannot be performed in combination are mixed together.

The processing of step S302 and step S303 are repeatedly executed until evaluation of all resources is completed. The processing of step S302, step S303, and step S304 which will be described later is repeatedly executed until all combinations of the operation amounts distributed to each resource at any ratio in step S301 are completed.

Next, the resource number calculation unit 134 calculates a resource cost (step S304). Specifically, the resource number calculation unit 134 calculates the resource cost based on the following Equation (6) by using a resource unit price defined in the resource cost table 117D.

resource cost of resource r=resource unit price x total number of required resources of resource r Equation (6)

For example, when the total number of resources by the operator of all products in the physical distribution center A is 1.5 [man-month] and the resource unit price is 2000 [$/man-month],

Resource cost of operator=2000[$/man-month]×1.5 [man-month]=3000[$].

In addition, when the total number of resources by the forklift of all products in the physical distribution center A is 2.3 [machine-month], and the resource unit price is 5000 [$/machine-month],

Resource cost of forklift=5000[$/machine-month]×2.3 [machine-month]=11500[$].

Next, the resource number calculation unit 134 adopts a distribution of the operation amounts with the minimum resource cost (step S305), and ends the processing of the flow.

Description will be given returning to FIG. 13. Next, the cost calculation unit 135 calculates a total cost of a combination of the inventory amount and the like distributed at any ratio (step S400). Specifically, the cost calculation unit 135 calculates the total cost by using the following Equation (7).

total cost=(fixed expense+resource cost)×period length+variable expense Equation (7)

Here, the fixed expense in Equation (7) is obtained by multiplying an added value of the cost of all warehouses defined as the fixed expense per unit period in the fixed expense table by a warehouse use flag that indicates whether the warehouse is used. Specifically, the cost calculation unit 135 calculates the fixed expense by using the following Equation (8).

fixed expense=Σ_{warehouse}{warehouse use flag×Σ(warehouse fixed expense)} Equation (8)

The warehouse use flag in Equation (8) has a value of “1” when a product amount such as the inventory amount and warehousing-delivery amount of the warehouse is larger than 0, or when there is a warehouse and the fixed expense is incurred even if the product amount is 0. Otherwise, the warehouse use flag has a value of “0”.

Further, as the resource cost in Equation (7), a value of the minimum resource cost among the resource costs obtained in Step S300 is used.

The variable expense in Equation (7) is calculated by using the following Equation (9).

variable expense=warehouse variation expense×transport expense Equation (9)

Here, the warehouse variable expense in Equation (9) is calculated by multiplying the product amount such as the inventory amount, the warehousing amount and the delivery amount of the warehouse by the unit price for each expense item defined in the variable expense table to calculate an expense item variable expense for each warehouse provided in the physical distribution network diagram, and adding up the expense item variable expense. Specifically, the cost calculation unit 135 calculates the warehouse variable expense by using the following Equation (10).

warehouse variable expense=Σ_{warehouse}(unit price per expense item×product amount per expense item)=Σ_{warehouse}(inventory storage unit price×inventory amount+warehousing unit price×warehousing amount+delivery unit price×delivery amount) Equation (10)

The transport expense in Equation (9) is calculated by adding up the transport expense per transport path obtained by multiplying the transport unit price defined in the transport path information 115 by the transport amount in each transport path for each transport path provided in the physical distribution network diagram. Specifically, the cost calculation unit 135 calculates the transport cost by using the following Equation (11).

transport expense=Σ_{transport path}(transport unit price×transport amount) Equation (11)

When the total cost is calculated by using the penalty cost value in lack of products defined in the condition table, Equation (7) is expressed by the following Equation (12).

total cost=(fixed expense+resource cost)×period length+variable expense+penalty cost value in lack of products×lack amount Equation (12)

Whether or not lack of products may be determined by various methods such as execution of a simulation by using the product amount of the prepared inventory deployment, or determination based on whether or not a ratio of the delivery amount to the inventory amount exceeds a predetermined ratio.

Next, the optimum inventory deployment selection unit 136 displays an inventory deployment with the minimum cost via the output processing unit 132 (step S500). Specifically, the optimum inventory deployment selection unit 136 specifies the inventory deployment having the minimum cost in the processing of step S100 to step S400, and causes the output device 302 to display information related to such inventory deployment via the output processing unit 132.

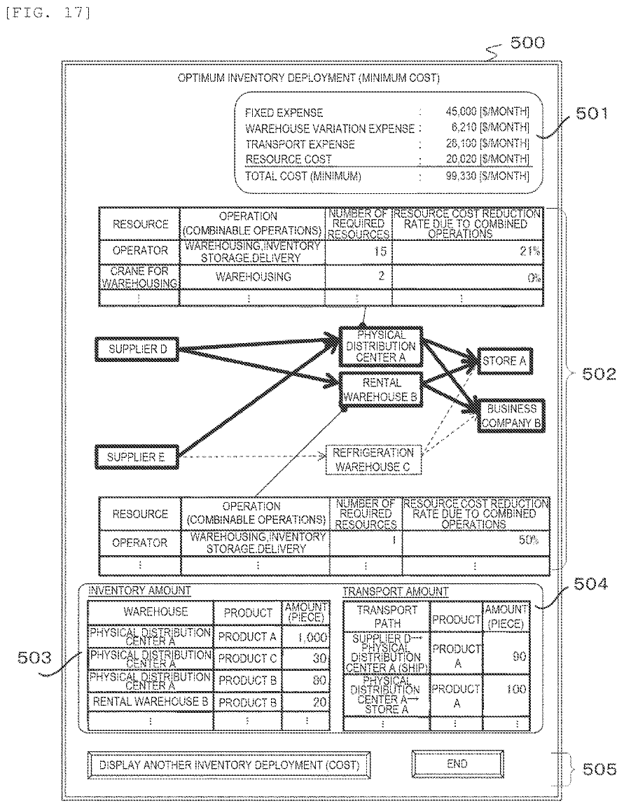

FIG. 17 is a diagram showing an example of screen information 500 that indicates the inventory deployment with the minimum cost. As shown in the drawing, a total cost display region 501, a resource display region 502, an inventory amount display region 503, a transport amount display region 504, and an instruction reception button region 505 are displayed on the display screen.

The total cost display region 501 is a display region in which the calculated total cost and breakdowns thereof are displayed. Specifically, in the total cost display region 501, the minimum total cost calculated in step S400, the fixed expense, the warehouse variable expense, the transport expense, and the resource cost which are the breakdowns thereof are displayed. Each of these values is a calculation result of each item calculated by using Equation (7) to Equation (12).

The resource display region 502 is a display region in which the physical distribution network diagram and information related to the resources of each warehouse are displayed. As shown in the drawing, the information related to the resource is table information in which a resource, an operation that includes combined operations, the number of required resources, and a resource cost reduction rate due to combined operations are associated with each warehouse.

The physical distribution network diagram is generated when the input information is read in step S100. In addition, the resource is specified for each warehouse in step S200 and step S300. Further, the operation is an operable operation (including one whether or not can be performed in combination) for each warehouse specified in step S300. The number of required resources is the number of resources required for each resource calculated in step S300.

The resource cost reduction rate is calculated by the cost calculation unit 135 using the following Equation (13).

Resource cost reduction rate=(Resource cost when not operating in combination−resource cost when operating in combination)/(resource cost when not operating in combination) Equation (13)

The inventory amount display region 503 and the transport amount display region 504 each indicate the inventory amount and the transport amount when the total cost calculated in step S400 is the minimum among the inventory amount and the transport amount distributed to each warehouse in step S200.

The instruction reception button region 505 is a display region in which a button that receives an instruction input from a user is displayed. Specifically, in the instruction reception button region 505, a button that receives a display instruction of another inventory deployment (cost) and an end button are displayed. For example, when the button that receives the display instruction of another inventory deployment (cost) is pressed, information that indicates the inventory deployment whose total cost is secondly minimal is selected by the optimum inventory deployment selection unit 136, and is displayed on the output device 302 via the output processing unit 132.

The output processing unit 132 may display breakdowns of the warehousing amount and the delivery amount of each warehouse or the cost of each warehouse. In addition, the output processing unit 132 may display not only information related to the inventory deployment with the minimum total cost and the cost thereof, but also information related to another inventory deployment and a cost that have been calculated, and information related to a current inventory deployment and a cost thereof, for example. When receiving the display instruction of another inventory deployment, the output processing unit 132 may display information related to a prescribed number (for example, three) of inventory deployments and costs in a list and the like in ascending order of the total cost, and may display information related to the inventory deployment selected from the list by the user and the cost thereof.

The inventory deployment planning device according to the first embodiment has been described above. According to such an inventory deployment planning device, it is possible to design an inventory deployment in which the distribution cost can be further reduced by considering performing combined operations. In particular, when the operations of inventory storage, warehousing and delivery can be performed in combination, the inventory deployment planning device can distribute the product amount and the operation amount of each resource so that the resources can be reduced by performing these operations in combination. Therefore, according to the inventory deployment planning device 100, the total cost can be minimized and the non-operation time of the resources can be reduced, so that the efficiency of the operation according to the inventory deployment can be improved.

### Second Embodiment

Next, a second embodiment of the invention will be described. In the first embodiment described above, an inventory amount is distributed to each warehouse at any ratio, and a combination of inventory deployments with the minimum total cost is specified by distributing a delivery amount, a warehousing amount, and a transport amount to all combinations of distribution at any ratio. However, in the present embodiment, the inventory deployment planning device 100 obtains ratios of a demand amount (the delivery amount) to a total inventory amount and a supply amount (the warehousing amount) to the total inventory amount for each product, and uses the ratios to calculate the delivery amount and the warehousing amount in each warehouse.

Basic configurations (a functional configuration, a hardware configuration, and the like) of the inventory deployment planning device 100 are the same as that of the first embodiment, and detailed descriptions thereof will be omitted. In addition, processing that differs from the first embodiment will be mainly described below.

For example, in a general warehouse that stores inventory, as the inventory amount increases, a scale of a base increases and processing capacity of warehousing and delivery tends to increase. Therefore, by fixing a ratio of the warehousing amount to the inventory amount and a ratio of the delivery amount to the inventory amount at each base to a ratio of the customer demand amount to the target inventory amount and a ratio of the supplier supply amount to the target inventory amount, respectively, an inventory deployment is obtained in which a small warehouse that stores a small amount of inventory can warehousing or deliver only a small amount of products, and a large warehouse such as a physical distribution center that stores a large amount of inventory can warehousing or deliver a large amount of products.

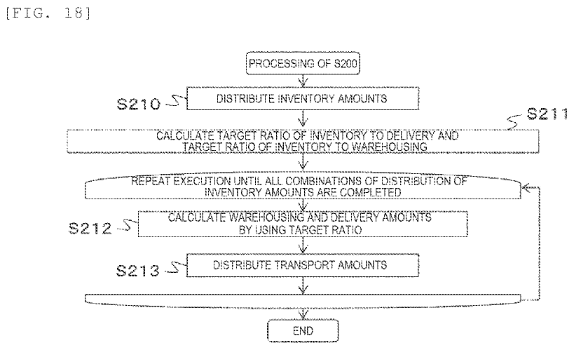

FIG. 18 is a flowchart showing details of processing of generating all combinations of inventory deployments in step S200 in FIG. 12.

In step S210, similarly to the first embodiment, the inventory deployment planning unit 133 distributes an inventory amount to each warehouse in a manner that covers any ratio and all combinations so that a sum of the inventory amounts of each product equals to a total inventory amount of the total inventory amount information 111.

Next, the inventory deployment planning unit 133 calculates a target ratio of inventory to delivery and a target ratio of inventory to warehousing (step S211). Specifically, the inventory deployment planning unit 133 calculates a target ratio of inventory to delivery for each product based on the following Equation (14) by using the total inventory amount information 111 and the customer demand amount information 112.

target ratio of inventory to delivery for product p=sum of demand amounts on product p/target total inventory amount of product p Equation (14)

In the total inventory amount information 111 in FIG. 2, the total inventory amount of a product A is 1000 pieces. In addition, in the customer demand amount information 112 in FIG. 3, a sum of the demand amounts of the product A is 100 pieces. Therefore, the inventory deployment planning unit 133 calculates, for example, the target ratio of inventory to delivery for the product A=100/1000=0.1.

The inventory deployment planning unit 133 calculates the target ratio of inventory to delivery for each product based on the following Equation (15) by using the total inventory amount information 111 and the supplier supply amount information 118.

target ratio of inventory to warehousing for product p=sum of warehousing amounts of product p/target total inventory amount of product p Equation (15)

In the total inventory amount information 111 in FIG. 2, the total inventory amount of the product A is 1000 pieces, and in the supplier supply amount information 118 in FIG. 9, the total warehousing amount of the product A is 90 pieces. Therefore, the inventory deployment planning unit 133 calculates, for example, the target ratio of inventory to warehousing for the product A=90/1000=0.09.

Next, the inventory deployment planning unit 133 calculates the warehousing and delivery amount by using the target ratio (step S212). Specifically, for each combination of the distribution of the inventory amount, the inventory deployment planning unit 133 calculates the delivery amount and the warehousing amount for each product by using the target ratio of inventory to delivery and the target ratio of inventory to warehousing calculated in step S211.

More specifically, the inventory deployment planning unit 133 calculates the delivery amount of the product p based on the following Equation (16).

delivery amount of product p=target ratio of inventory to delivery for product p×inventory amount of distributed product p Equation (16)

For example, when the target ratio of inventory to delivery for the product A is 0.1 and the inventory amount of the product A distributed to a certain warehouse is 500 pieces, the inventory deployment planning unit 133 calculates the delivery amount of the product p=50 pieces.

The inventory deployment planning unit 133 calculates the warehousing amount of the product p based on the following Equation (17).

warehousing amount of product p=target ratio of inventory to warehousing of product p×inventory amount of distributed product p Equation (17)

For example, when the target ratio of inventory to warehousing of the product A is 0.09 and the inventory amount of the product A distributed to a prescribed warehouse is 500 pieces, the inventory deployment planning unit 133 calculates the warehousing amount of the product p=45 pieces.

Next, similarly to the first embodiment, the inventory deployment planning unit 133 distributes the transport amount to each transport path (step S213). Specifically, for each combination of the inventory amount, the delivery amount and the warehousing amount that are distributed, the inventory deployment planning unit 133 distributes the transport amount to each transport path in which the warehouse is set to be the transport origin in a manner that covers any ratio and all combinations so that the transport amount is equal to the delivery amount of each product in each warehouse calculated in step S212. In addition, the inventory deployment planning unit 133 distributes the transport amount to each transport path in which the warehouse is set to be the transport destination in a manner that covers any ratio and all combinations so that the transport amount is equal to the inventory amount of each product in each warehouse calculated in step S212. The inventory deployment planning unit 133 distributes a transport amount of a product to each transport vehicle in a manner that covers any ratio and all combinations.

The processing of step S212 and step S213 are repeatedly executed until all combinations of the distribution of the inventory amounts are completed.

Similarly to the first embodiment, when the above processing is completed, the inventory deployment planning unit 133 proceeds to the processing of step S300 (FIG. 12).

The inventory deployment planning device according to the second embodiment has been described above. According to such an inventory deployment planning device, it is possible to design an inventory deployment in which the distribution cost can be further reduced by considering performing combined operations. Particularly, the inventory deployment planning device calculates the target ratio of inventory to delivery and the target ratio of inventory to warehousing, and uses the target ratios to calculate the delivery amount and the warehousing amount for each product in each warehouse, so that the product amounts can be determined according to a real warehouse. Further, according to the inventory deployment planning device of the present embodiment, it is possible to significantly reduce the processing necessary for specifying the inventory deployment with the minimum total cost, as compared with the first embodiment.

Although the product amounts such as the inventory amount for each product is calculated in the above-described embodiments, the number of products to be a target may be enormous. In such a case, a plurality of products may be grouped as a product group in which a plurality of products are grouped, and the total inventory amount may be treated as the sum of the inventory amounts of the products included in the product group. Accordingly, the amount of data processing can be significantly reduced in the inventory deployment planning device.

In addition, although the above embodiments have been described by way of example of three-step supply chain of supplier, warehouse and customer, the invention can also be applied to a supply chain of multi-tiered and complex transportation paths.

Further, although the above embodiments have described the case of generating all combinations of inventory deployments, the invention is not limited to such a method, and for example, a combination of inventory deployments with the minimum cost may be calculated by a mathematical optimization method such as mixed integer programming.

The invention is not limited to the embodiments described above, and includes various modifications. For example, the embodiments described above have been described in detail for easy understanding of the invention, and is not necessarily limited to those including all the configurations described above. Further, a part of the configuration of one embodiment can be replaced with a configuration of another embodiment, and the configuration of another embodiment can be added to the configuration of one embodiment. A part of the configuration of each embodiment may be added, deleted, or replaced with another configuration.

Further, in the above description, a control line and an information line are shown in consideration of necessity for description, and not all control lines and information lines are necessarily shown in the product. In practice, it can be considered that almost all the configurations are interconnected.

### REFERENCE SIGN LIST

100 . . . inventory deployment planning device, 110 . . . storage unit, 111 . . . total inventory amount information, 112 . . . customer demand amount information, 113 . . . product information, 114 . . . warehouse information, 115 . . . transport path information, 116 . . . cost information, 117 . . . combined operation availability information, 118 . . . supplier supply amount information, 119 . . . operation load information, 130 . . . calculation unit, 131 . . . input reception unit, 132 . . . output processing unit, 133 . . . inventory deployment planning unit, 134 . . . resource number calculation unit, 135 . . . cost calculation unit, 136 . . . optimum inventory deployment selection unit, 140 . . . communication unit, 200 . . . external device, 201 . . . database, 202 . . . information management unit, 203 . . . communication unit (external device), 301 . . . input device 302 . . . output device 303 . . . external storage device, 304 . . . calculation device, 305 . . . main storage device, 306 . . . communication device, 307 . . . bus, N . . . network

1. An inventory deployment planning device, comprising:
an inventory deployment planning unit configured to distribute an inventory amount, a delivery amount and a warehousing amount to each warehouse at any ratio based on a total inventory amount of a product, a demand amount and a supply amount of the product, and to distribute an operation amount of each operation to a prescribed resource in each warehouse at any ratio based on the inventory amount, the delivery amount and the warehousing amount;
a resource number calculation unit configured to calculate the number of required resources of the resource based on the operation amount, and to calculate a total number of resources according to a prescribed rule in a case where there is operations that are able to be performed in combination among the operations so that the number of resources is reduced compared to a case where the operations are not able to be performed in combination;
a cost calculation unit configured to calculate a resource cost based on the total number of resources; and
an optimum inventory deployment selection unit configured to specify an optimum inventory deployment in a supply chain in which inventory amounts are distributed to each warehouse at any ratio by using the resource cost.

2. The inventory deployment planning device according to claim 1, wherein
the resource number calculation unit is configured to, in a case where the operations are able to be performed in combination, perform calculation by taking the largest number of required resources, among the numbers of required resources calculated for each operation that is able to be performed in combination, as the total number of resources.

3. The inventory deployment planning device according to claim 1, wherein
the resource number calculation unit is configured to, in a case where the operations are able to be performed in combination, calculate the total number of resources to be a value between the largest number of required resources among the numbers of required resources calculated for each operation that is able to be performed in combination, and a total value of numbers of required resources calculated for each operation that is able to be performed in combination.

4. The inventory deployment planning device according to claim 1, wherein
the inventory deployment planning unit is configured to:
calculate a target ratio of inventory to delivery based on the total inventory amount and the demand amount,
calculate a target ratio of inventory to warehousing based on the total inventory amount and the supply amount, and
calculate distribution amounts of the delivery amount and the warehousing amount to each warehouse by using the target ratio of inventory to delivery and the target ratio of inventory to warehousing.

5. The inventory deployment planning device according to claim 4, wherein
the inventory deployment planning unit is configured to calculate the distribution amounts of the delivery amount and the warehousing amount by multiplying the target ratio of inventory to delivery and the target ratio of inventory to warehousing by the inventory amounts distributed to each warehouse at any ratio.

6. The inventory deployment planning device according to claim 1, wherein
the optimum inventory deployment selection unit is configured to specify an inventory deployment with the minimum total cost in the supply chain calculated by using the resource cost as an optimum inventory deployment.

7. The inventory deployment planning device according to claim 6, wherein
the cost calculation unit is configured to add a prescribed penalty cost to the total cost in lack of the product due to the inventory deployment.

8. The inventory deployment planning device according to claim 1, further comprising:
an output processing unit configured to generate screen information that includes
a physical distribution network diagram showing the supply chain;
the resources, the operations and the number of required resources in each warehouse;
a cost of a prescribed expense including the resource cost; and
the inventory amount for each warehouse and for each product.

9. An inventory deployment planning method that is performed by an inventory deployment planning device, the inventory deployment planning method comprising:
causing the inventory deployment planning device to perform:
an inventory deployment planning step of distributing an inventory amount, a delivery amount and a warehousing amount to each warehouse at any ratio based on a total inventory amount of a product, a demand amount and a supply amount of the product, and distributing an operation amount of each operation to a prescribed resource in each warehouse at any ratio based on the inventory amount, the delivery amount and the warehousing amount;
a resource number calculation step of calculating the number of required resources of the resource based on the operation amount, and calculating a total number of resources according to a prescribed rule in a case where there are operations that are able to be performed in combination among the operations so that the number of resources is reduced compared to a case where the operations are not able to be performed in combination;
a cost calculation step of calculating a resource cost based on the total number of resources; and
an optimum inventory deployment selection step of specifying an optimum inventory deployment in a supply chain in which inventory amounts are distributed to each warehouse at any ratio by using the resource cost.
